(19) United States
(12) Patent Application Publication
(10) Pub. No.: US 2014/0249898 A1
(43) Pub. Date: Sep. 4, 2014

(54) SPONSORSHIP PLATFORM SYSTEMS AND METHODS

(71) Applicant: Meredith Leigh Ostoich, Cincinnati, OH (US)

(72) Inventor: Meredith Leigh Ostoich, Cincinnati, OH (US)

(21) Appl. No.: 14/192,727

(22) Filed: Feb. 27, 2014

Related U.S. Application Data
(60) Provisional application No. 61/935,557, filed on Feb. 4, 2014.
(60) Provisional application No. 61/770,055, filed on Feb. 27, 2013.

(51) Int. Cl. G06Q 30/02

(52) U.S. Cl. CPC G06Q 30/0241
USPC 705/14.4

(57) ABSTRACT

A manufacture, comprising a non-transitory non-volatile computer-readable storage device that can include computer-readable code for managing a sponsorship transaction and interpretable by a processor to cause a computing system to perform a process that can include including presenting to a user a human-readable representation of a plurality of objectives, receiving from the user a designated business objective, storing, in a first data record of a database, the designated business objective, presenting to the user a human-readable representation of a plurality of criteria, receiving from the user a designated criteria, storing, in the database, the designated criteria in a second data record, based on receiving the designated business objective and the designated criteria, matching a property, and presenting to the user a human-readable representation of the property.

### REFERENCE TO RELATED APPLICATIONS

The present application claims the priority benefit of U.S. provisional patent application Ser. No. 61/935,557, filed Feb. 4, 2014, and U.S. provisional patent application Ser. No. 61/770,055, filed Feb. 27^{th}, 2013, and hereby incorporates the same applications herein by reference in their entirety.

### TECHNICAL FIELD

Embodiments of the technology relate, in general, to sponsorship platform technology, and in particular to systems and methods for efficient sponsorship management and commerce.

### SUMMARY

A manufacture, comprising a non-transitory non-volatile computer-readable storage device that can include computer-readable code for managing a sponsorship transaction and interpretable by a processor that can cause a computing system to perform a process that can include including presenting to a user a human-readable representation of a plurality of objectives, receiving from the user a designated business objective, storing, in a first data record of a database, the designated business objective, presenting to the user a human-readable representation of a plurality of criteria, receiving from the user a designated criteria, storing, in the database, the designated criteria in a second data record, based on receiving the designated business objective and the designated criteria, matching a property, and presenting to the user a human-readable representation of the property.

### BACKGROUND

In the current sponsorship environment, if a buyer wants to sponsor an event they would generally contact the corporate sales team representing the event and inform them of their sponsorship interest. They sales team would then meet with the buyer to review the buyers objectives. They sales team would then go back and evaluate options based on the buyer's budget and availability, which may be listed in a spreadsheet or other similar format. Based on this review, the sales team will then generate a proposal, have the pricing reviewed, approved, and signed off on internally, and then have the proposal sent over to the client. The first part of the process can take several days. Once the proposal is received, the buyer will review it, circulate it internally, and have lawyers review the document. This part of the process can also take several days or more. There are usually several rounds of revisions to the sales proposal and the parties do their best to keep track of the most recent version.

There are gross inefficiencies built into existing sponsorship management systems. Because sponsorships are constantly being discovered and re-worked, the delay associated with each round of review can be costly. The importance of such decisions, the number of interested parties, and the complexity of negotiations has rendered existing systems obsolete.

### BRIEF DESCRIPTION OF THE DRAWINGS

The present disclosure will be more readily understood from a detailed description of some example embodiments taken in conjunction with the following figures:

FIG. 1 depicts an example system diagram depicting a sponsorship management computing system according to one embodiment.

FIG. 2 depicts an example flow chart depicting a method associated with a sponsorship management computing system according to one embodiment.

FIG. 3 depicts an example flow chart of a system and method associated with a sponsorship management computing system according to one embodiment.

FIG. 4 depicts an example flow chart of a system and method for creating a new inventory concept.

FIG. 5 depicts an example flow chart of a system for aggregating data to improve the predictive analytics for a sponsorship management computing system.

FIG. 6 is a screenshot depicting one version of a display for a sponsorship.

FIG. 7 is a screenshot depicting one version of a display for a search inventory.

FIG. 8 is a screenshot depicting one version of a display for a sponsor profile.

FIG. 9 is a screenshot depicting one version of a display for an inventory.

FIG. 10 is a screenshot depicting one version of a display for a sponsor campaign.

FIG. 11 is a screenshot depicting one version of a display for a sponsor wishlist.

FIG. 12 is a screenshot depicting one version of a display for a property profile.

FIG. 13 is a screenshot depicting one version of a display for a property campaign.

FIG. 14 is a screenshot depicting one version of a display for a quote proposal.

FIG. 15 is a flow chart depicting one version of data diagram according to one embodiment.

FIG. 16 is a flow chart depicting a version of a method for providing targeted sponsorship suggestions.

### DETAILED DESCRIPTION

Various non-limiting embodiments of the present disclosure will now be described to provide an overall understanding of the principles of the structure, function, and use of the proficiency tracking systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment”, or “in an embodiment” in places throughout the specification are not necessarily all referring to the same embodiment. Furthermore, the particular features, structures or characteristics may be combined in any suitable manner in one or more embodiments.

Sponsorship can help build attention, support, and loyalty for brands in an environment that may otherwise be hostile to marketing communications. Sponsorship has, in many cases, become elevated to the corporate strategic planning conversation and may be more likely to be discussed in the context of integrated marketing programs that can take advantage of the reach of traditional advertising as well as the emotional and experimental benefits earned through partnerships w/ sports and entertainment. More decision makers are now generally involved with the planning, execution, and evaluation of sponsorship deals. Buyers have raised the stakes in many cases, which has also increased the number of internal decision-makers to satisfy such buyers. These buyers often place high demands on properties to prove value and return. The current process of selling and managing sponsorship deals is disconnected and doesn't communicate. Existing systems lack a central way to integrate the data and collaborate both internally and with their sponsors.

Described herein are example embodiments of computer-based systems and methods for creating sponsorship or advertising deals with a sponsorship management computer system. The sponsorship management computer system can include a sponsorship marketplace that can act as a foundational framework for properties to easily and efficiently engage with sponsors. The sponsorship management computer system can make it easier for properties to engage with sponsors and to plan, negotiate, or execute sponsorship campaigns across multiple media types. The sponsorship management computer system can give sponsors the freedom to build their own sponsorship package on their own terms. In one embodiment, a sponsor can make all of their sponsorship marketing decisions in one place. Properties, which can include sport teams, venues, leagues, non-profits, businesses, and agencies, can also engage with the sponsorship management computer system to market available sponsorships.

Systems described herein can include a cloud-based platform that can be aimed to overcome the challenges of both buyers and seller of sponsorships and to assist in achieving a number of desirable objectives. For example, systems and methods described herein can provide sponsors with more data, properties with more opportunities to sell sponsorships, buyers with more options and more accurate sponsorship options to select from. Systems and methods described herein can also be adapted in real time or near real time to an ever-changing business landscape.

In an example embodiment, properties can manage all of their sponsorship assets in one central location and can have the ability to add new sponsorships at any time. Properties can add pictures, videos, testimonials, price, tag words, availability, or any data relevant to a specific sponsorship. Properties can quickly create custom proposals to include information on each sponsorship asset they are pitching, and properties can then track the contracts easily as they are negotiated. Such a system can allow all decision makers to see the most up-to-date versions of a contract or proposal and can eliminate circulating unnecessary e-mails or hard copies regarding a document. In an example embodiment, with the sponsorship management computer system, properties can generate custom reports about their entire sponsorship sales channel. This can include information from sales numbers, the availability status of all sponsorship assets, information, information from all or any account user sales information, a master list of all sponsorship assets, inventory status, Sponsor 310 information, custom reports based on anything being tracked by the system 100, or the like.

Buyers can educate themselves on the different sponsorship opportunities available by using the sponsorship management computer system. For example, buyers can search based on what they are looking for and can view exact sponsorship images and videos. Buyers no longer need to be at the mercy of solely being educated from a catalog, which may be outdated, or from a specific sales representative. By having the ability to educate themselves at the onset of the buying decision, buyers or sponsors may be able to have deeper, more meaningful dialogues with corporate sales representatives, or avoid sales representatives altogether. In an example embodiment, sponsors can pro-actively build a sponsorship campaign online, articulate their priorities, and can include a budget amount if they choose. Sponsors can create reports in real time per property, or multiple properties, which can make it efficient to get the information they need, when they need it. All documentation can be neatly stored on one platform, which can make it efficient to control deal negotiations and ultimately can accelerate the time it takes to execute contracts.

The sponsorship management computer system's platform can create an sightline for sponsors to find and search other similar properties in the system. The system can allow sponsors to more readily connect with multiple properties and can provide enhanced search functionality. Buyers can be able to cross-search options and have more sponsorship options to choose from, which can in turn allow buyers to better match with their sponsorship objectives. Such a system and method may have multiple benefits to the properties using the system such as additional revenue, new business leads, new business leads from perspective buyers, or incentive to better organize and expand upon information available per sponsorship asset because data information can be searchable in the system 100.

The sponsorship management computer system can include a marketplace, which can connect buyers and sellers online. The marketplace can allow buyers to access multiple properties in one place. The system can include a data aggregation tool that can connect data such as CRM, sales information, and data regarding sponsorship assets or information, for example. The system can include an API that can push or pull data for properties and buyers.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

A sponsorship management computer system can execute software for the creation, organization, or consummation of deals, as described in more detail below. The sponsorship management computer system can run on any suitable computing system, such as a dedicated server, a user computer or server, multiple computers, a collection of networked computers, a cloud-based computer system, a web-based computer system, or from a storage device, for example. One or multiple processing units, such as central processing units and/or graphics processing units, may perform instructions stored in memory to execute the processes described herein.

A sponsorship management computer system in accordance with the present disclosure can be accessed via any suitable technique, such as a web-browser such as SAFARI, OPERA, GOOGLE CHROME, INTERNET EXPLORER, or the like executing on a client device. In some embodiments, the systems and methods described herein can be a web-based application or a stand-alone executable. Additionally, in some embodiments, the systems and methods described herein can integrate with various types of advertising, database, e-commerce, or other suitable systems. Any suitable client device can be used to access, or execute, the sponsorship management computing system, such as laptop computers, desktop computers, smart phones, tablet computers, gaming system, and the like.

Systems and methods described herein may generally provide a paperless environment for users (e.g., the system can be entirely digital from start to finish) to identify and purchase or sell sponsorships. Interaction with the sponsorship management computer system may include, without limitation, keyboard entry, writing from pen, stylus, finger, or the like, with a computer mouse, or other forms of input (voice recognition, etc.). The system may be presented on a tablet, desktop, phone, board, or paper. In one embodiment, the user may interact with the system by writing with a smart pen on normal paper, modified paper, or a hard flat surface of their preference. In this embodiment, the user may receive real-time feedback, or at least near real-time feedback, or may synchronize with a sponsorship management computer system at a later date. The sponsorship management computer system can be a personal computer, one or multiple computers in server-type system.

User interaction with the sponsorship management computer system may take place in any of a variety of operational environments, such as a work setting or a home setting, with one or more users interacting with the system at a given time.

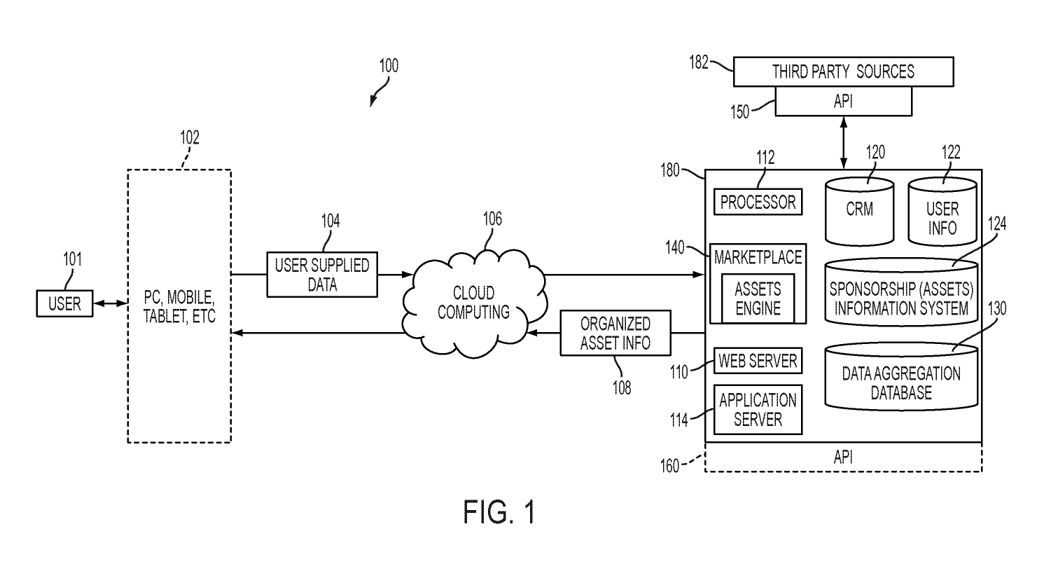

Referring now to FIG. 1, an example system diagram for one version of a sponsorship management computer system 100 is shown. The sponsorship management computer system 100 can include, for example, any suitable elements or features such that a user 101, including buyers or sellers of sponsorships or advertising, can interact to search, buy, sell, and manage such sponsorships or advertising. The sponsorship management computer system 100 can include an information management system and a marketplace that can connect buyers and sellers to assist with sponsorships management and commerce. Sponsorship can include advertising, partnerships, traditional or non-traditional forms of advertisement, ticket packages, hospitality experiences, or the like that could assist a buyer in meeting their sponsorship objectives. A buyer can include, for example, any entity seeking a sponsorship or an agency or similar entity looking to assist a buyer. A seller may be a property, such as a sports team, venue, league, event, non-profit, entertainment entity, or anyone including individuals that may have sponsorships to market. The following example elements of the sponsorship management computer system 100 can be integrated or otherwise communicate based upon a user's needs. It will be appreciated that the elements, and the function of the elements, is provided by way of example only.

Still referring to FIG. 1, the sponsorship management computer system 100 can include peripheral devices 102, which can be used to access the sponsorship management computer system 100, associated platforms, or to connect to the cloud. Peripheral devices 102 may include a computer, cell phone, tablet, or any other electronic device. The sponsorship management computer system can include user data 104, which can include data provided by a user, such as sponsorship information, financial information, personal information, or the like, that can be used by the sponsorship management computer system 100. For sellers, user data 104 can include sponsorship assets and information that can assist in defining the sponsorship. For buyers, user data 104 can include general information about the system, selected search criteria, search criteria, communicating priorities, updating contracts, any other supplied information, or the like. The sponsorship management computer system can include the cloud 106, or any other suitable technology or mechanism by which information can be stored or processed.

The sponsorship management computer system 100 can include organized asset information 108, which can comprise the output or results from selections made by a buyer or seller. Organized asset information 108 can include any suitable information depending on the needs of the user including sponsorship assets, a group of assets, reports, a campaign, proposal, results from search criteria, or any other task the sponsorship management computer system is capable of completing.

The sponsorship management computer system 100 can include a computer 180 that can aggregate, process, or connect information in one place and can provide desirable information regarding sponsorships to a buyer or seller. The computer 180 can include a processor 112, a web server 110, an application server 114, a CRM 120, user information 122, sponsorship information 124, a data aggregation database 130, and a marketplace engine 140. It will be appreciated that third party system 182 can communicate with the sponsorship management computer system via, for example, a third party API 150. The sponsorship management computer system 100 can be associated with an API that can with external systems. The sponsorship management computer system can be configured to push or pull data as needed.

The CRM 120 can be associated with the computer 180 having a processor 112 and can include customer relationship management information or any other suitable information, where it may be beneficial to maintain customer information in a single location. The CRM 120 can include general information and can include the ability to connect with third party CRM systems if desirable. User information 122 can be associated with the CRM 120 and can include user information collected by the system 100 that can be associated with a buyer or seller account, for example. This may include company or property information, personnel information, and associated demographics that can represent the users. This can include general information, staff information, demographics that make up a fan base or any information important, suitable, or directed to buyers. This information can be added to a database 130 that can be searchable by the system 100.

Sponsorship information system 124 can be stored in the system 100. In one embodiment, a user 101 can input or otherwise add sponsorship assets or information into the sponsorship information system 124 of system 100. The sponsorship information system 124 can include a sponsorship category, description, price, picture, testimonials, video, tag words to the sponsorship asset, data, metadata, a business objective metric, or any other suitable data fields about one or a plurality of sponsorships. Sponsorship information system 124 can include partnership information, media, hospitality information, tickets, or the like. Sponsorships can be built to achieve different objectives. All of the information tied to the sponsorships can then be searchable in the sponsorship information system 124 of the system 100. The information can be retained within a central location such as computer 180, within the cloud 106, or in any other suitable location. The data aggregation database 130 can also be configured to retain sales data or other suitable data.

The data aggregation database 130 can be configured to retain any suitable data and can be accessed by the processor 112. The processor 112 can associate and process user information, sponsorship information, sales data, or the like to generate sponsorships, proposals, or the like. The processor 112 can incorporate information from any suitable third party API 150 from a third party source 182 that can be connected to the system 100. Information from a third party API 150, database 130, sponsorship information system 124, user information 122, and/or CRM by the processor 112 to create custom reports, sponsorships, or any suitable organized asset info 108. Information or the like can also be or information may be pushed out through the API 16.

The system 100 can be configured such that a user 101 can create custom reports based on the information in the system 100. With market penetration the processor 112 can develop smart algorithms and can also have the ability to draw industry wide reports. The system 100 can suggest properties or assets based on history or requested searches by a user 101. The system 100 can include a marketplace engine 140. In addition to the system 100 or platform acting as an information system, buyers and sellers can collaborate in one central place such as marketplace 140. The system 100 can include a comprehensive search engine that can easily find desired results.

The system 100 can be configured to create collaboration between users 101 and to create new sponsorships. Such collaboration can be associated with the marketplace 140 of the computer 180. Buyers can have the ability to access seller(s) sponsorship assets, ability to find new sellers, to search for sponsorships from an individual seller's sponsorship or from multiple sellers at once, create/purchase/manage sponsorship packages, or create new sponsorships. Sellers can post available inventory, catalog inventory, or create new sponsorships, for example. There is also additional value that can happen my multiple sellers using the same system to inventory sponsorship assets. The marketplace 140 can act as a tool for sellers to stay current based on the sponsorships other sellers are creating or what buyers are asking for. The reports that can be drawn can be real time or near real time.

The system 100 can be configured to accept a third party API 150 or a plurality of third party API's. As new technologies are being created at a rapid pace, the system can be configured to pull in data from outside sources. This can include existing CRM software, accounting software, or the like. The system 100 can include an API 160, where the API of the system 100 can available to be repurposed into other systems.

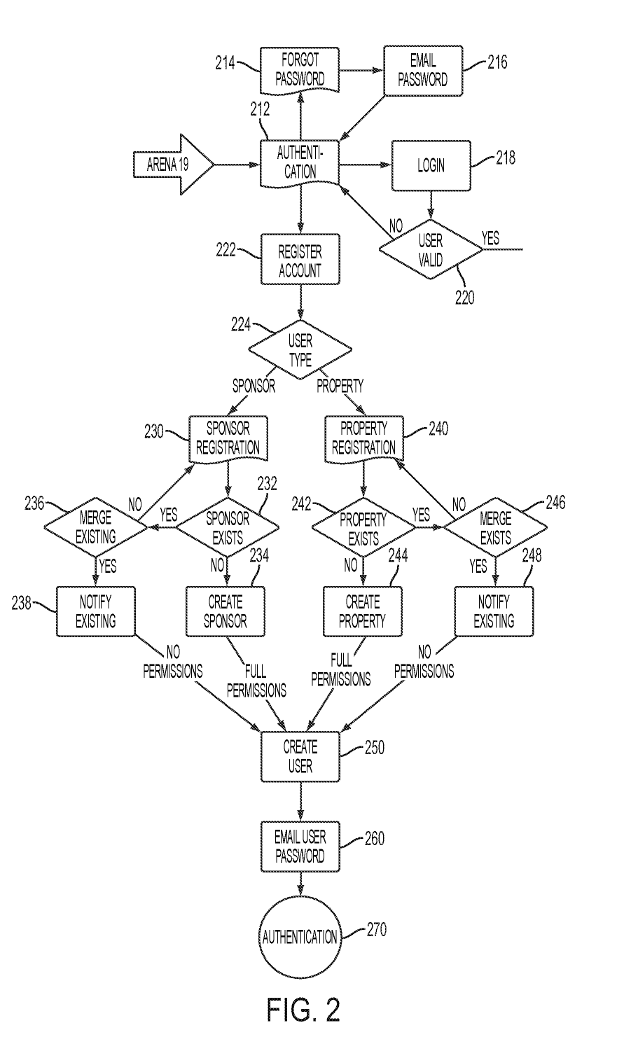

In some embodiments, the system 100 can be used with any suitable method having any suitable number of steps. Example methods are provided below. Referring to FIG. 2, a method 200 depicts one version of how a user 101 can use the system 100 to login or register as a new user. FIG. 2 depicts one version of how a user 101 can register a new account. The user 101 may go through a series of steps, such as Authentication 212, Identify User Type 224, Existing Account Determination 232, 242, and Create User 250

Method 200 can be used to authenticate or otherwise ensure that a user 101 is logging in under the correct identity of or listing sponsorships with the correct identify, for example. Method 200 can also be used to establish personal, credit, or other information that can be used with the system 100 (FIG. 1). It will be appreciated that the method 200 can be performed by the system 100, in association with the system 100 or in any other suitable manner.

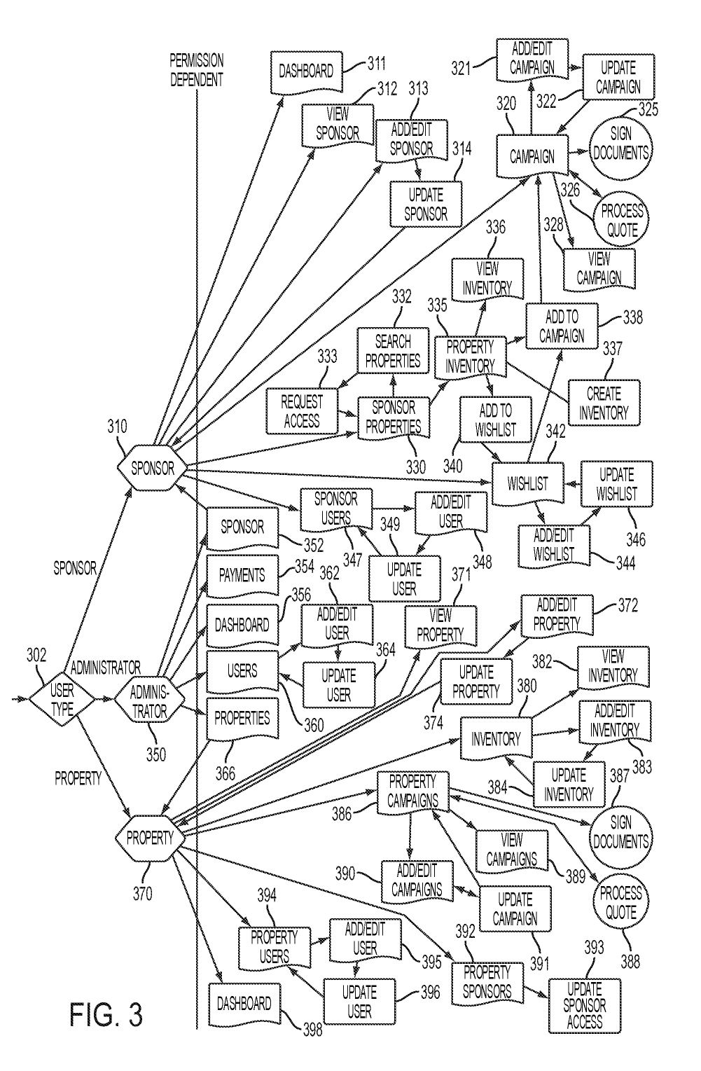

Method 200 can include any suitable steps such as, for example, Authentication 212. Authentication 212 can include verifying that a user 101, such as a business or individual, is who they say they are. Authentication 212 can include the use of passwords, third party authentication, bio-metrics, two-step verification, or the like. The method 200 can include user Login 218, where Login 218 can include having a user input sufficient information such that the system 100 can verify the user 101 identity. For example, the system 100 can store user information 122 in a database 130 (FIG. 1) and the system 100 can access this user information 122 during the Login 218 such that a user 101 identity can be confirmed. If the user 101 enters a correct password in accordance with User Valid 220, the user 101 can proceed to the system and method 300 as illustrated in FIG. 3.

Method 200 can include Forget Password 214. If a user 101 forgets their login credentials, the user 101 can select “Forget Password” and the system 100 can send the user 101 their password in accordance with Email Password 216. The system 100 can push an e-mail to the user 101 informing them of a newly created password or can include a link to create a new password. The method can then proceed back to Authentication 212. If the user 101 can successfully enter their password in accordance with Login 218 and User Valid 220 then the user 101 can proceed to the system and method 300 as illustrated in FIG. 3.

Method 200 can include Register Account 222, where when a user 101 is unable to access the system 100 and does not have a user profile they will need to establish a new profile. The user 101 can register an account with the system 101 in any suitable manner, such as by inputting appropriate information into the system 100. Register Account 222 can include asking the user 101 to add information such personal information including company name, first name, last name, e-mail address, phone number, billing information, or the like to determine whether a company or user match already exists or if it is a unique account. The user 101 can also select User Type 224, which can include Sponsor Registration 230 or Property Registration 240, for example. It will be appreciated that any suitable user type is contemplated, where any suitable number of registrations can be associated with any number of such user types.

Method 200, after receiving input regarding Register Account 222 and User Type 224, can determine if a Sponsor Exists 232 or if a Property Exists 242 that is associated with the information entered by the user 101. If an account or property already exists, the user 101 can choose to merge the existing account in accordance with Merge Existing 236 and Merge Existing 246, respectively, by notifying the existing sponsor account (Notify Existing 238) user or property account user (Notify Existing 248). In this manner, associated sponsors or properties can be merged such that all related accounts or properties can be organized and more efficiently managed. In the event that the account, property, or sponsor is unique, the user 101 can Create Sponsor 234 or Create Property 244. It will be appreciated that any suitable number or type of accounts can be created. One embodiment can include allowing a user 101 to have access to one or multiple accounts of different or the same user type, where multiple accounts can be accessible under the same login, for example. Permissions can be based upon whether an account is new or is being merged with an existing account, where a new account can allow for any suitable permission to be set and an existing account can grant pre-determined, limited, or no permissions to the user 101.

In accordance with method 200 according to one embodiment, after a user has entered information to create an account, it has been determined if there is an associated existing account, sponsor, or property, and permissions have been determined, the method can proceed to Create User Profile 250. Create User Profile 250 can include establishing a user 101 profile within the system 100 that can include a login, password, associated account, personal information, and associated permissions. Method 200 can then proceed to Email User Password 260 such that the user 101 can proceed to Authentication 270. Authentication 270 can correspond with Authentication 212, where a user 101 can successfully input their information to access the system 100 and proceed to the system and method 300 as illustrated in FIG. 3.

It will be appreciated that method 200 is illustrated by way of example only. For example, any suitable steps, such as visiting a website, selecting a login, choosing a user type, or the like can be included. It will be appreciated that the steps are of method 200 are described by way of example only, where any suitable order or number of steps is contemplated.

FIG. 3 depicts one version of a method 300 for how different user types can use the sponsorship management system 100 (FIG. 1). The system and method 300 includes the user types Sponsor 310, which can include a buyer, Property 370, which can include a seller, or Administrator 350. Each user can vary based on permission levels and it will be appreciated that any suitable number or type of users are contemplated. Users can have full access for each user type as describe below, but any suitable access including limited access is contemplated. Sponsor 310 can include a sponsor, buyer, corporation, agency, brand or someone interested in sponsorship or partnership opportunities, for example. Property 370 can be any type of seller, such as a sport team, league, venue, non-profit, event, music artist, or anyone looking to offer sponsorship or partnership opportunities, for example. Administrator 370 can be anyone that can access the system 100 on behalf of a system provider for example.

In FIG. 3, one embodiment of a system and method 300 is illustrated that can demonstrate how a Sponsor 310 can access the system 100. Sponsor 310 can interact with a Dashboard 311 and the Sponsor 310 can have the ability to View Sponsor 312. View Sponsor 312 can include viewing any aspect of the account associated with the Sponsor 310. The sponsor 310 can Add/Edit Sponsor 313 details, which can include providing a description, providing an image, or including any other suitable sponsor information. The Sponsor may be able to Update Sponsor 314 in real time or near real time, where Update Sponsor 314 can include manual updating, automating updating by the system 100, updating from third parties, or updating by any other suitable method. The Sponsor 310 can view all of their existing sponsorships, Campaign 320, Sponsor Properties 330, or the like via the Dashboard 311.

System and method 300 can include a step for Sponsor 310 to create Campaigns 320. This can allow a sponsor to Add/Edit a Campaign 321, such as to add inventory item, add comments to communicate priorities, add activation methods, planning tools, or any other suitable tasks that may be possible in a sponsorship or partnership campaign. Campaigns 320 can also be associated with Update Campaign 322 changes, which can include making or saving changings, or View Campaign 328, Process Quote 326, or Sign Documents 325. Process Quote 326 can include generating a quote based upon sponsorship or campaign information and Sign Document 325 can include electronically executing binding documents to complete a transaction related to a sponsorship.

System and method 300 illustrates one embodiment of how a Sponsor 310 can connect with one or a plurality of Properties 370. In one version, the Sponsor 310 can access Sponsor Properties 330 and can Search Properties 332, which can include inputting and searching relevant search criteria related to Properties 370. Such information can be associated with the database 130 or sponsorship information system 124 describe with reference to FIG. 1. One embodiment of Search Properties 332 can include the ability for a Sponsor 310 or Property 370 to search a single property or multiple property sponsorship assets simultaneously.

Search Properties 332 can also include an advance search, which can include the ability for a user 101 to search, or pair, by price, date range, category type, tag words, or any other suitable data point for a single or multiple properties simultaneously. The system 100 can then yield or otherwise deliver or report results accordingly. It is also appreciated that Search Properties 332 can include any combination of suitable search criteria.

Search Properties 332 can also include pairing unique factors. It is appreciated that this can include the ability to pair any information. This can mean that if a user 101 is looking to achieve a specific return on objective or return on investment, the pairing can be selecting from a pool of objectives, the system 100 can generate suitable sponsorship assets to match the specific request. By maintaining large amounts of data associated with sponsors and properties, the system 100 may be able to efficiently and accurately match the needs of any User Type 302. For example, matching the search criteria of a user 101 can yield one or more Properties 370 that may meet the objective(s) of the user 101. The system 100 can also pair to search criteria such as, for example, a Sponsor 310 may be seeking to understand which Properties can achieve desired objectives.

System and method 300 can include a Sponsor 310 Requesting Access 333 from a Property 370. Requesting Access 333 can be associated with View Inventory 336, additional sponsorship opportunities, or with any other suitable feature of the system and method 300. It will be appreciated that a Sponsor 310 can gain access to a Property 370 in other ways, such as a Property 370 granting access and sending a pre-approved push notification to a sponsor 310.

In one embodiment of the system and method 300, a Sponsor 310 can be granted access to Property Inventory 335. The Sponsor 310 can use this access to View Inventory 336 information, such as view images, read testimonials, see availability, or any other suitable information available per sponsorship inventory item. System and method 300 shows how a Sponsor 310, with access to a Property 370, may Add an Inventory Item to a Campaign 338. A Sponsor 310 can create a Campaign 320 with multiple inventory items to create a mixed sponsorship category package. A user 101 may find it valuable to meet their objectives or sponsorship spending to include a variety of sponsorship types.

System and method 300 depicts one embodiment of how a user 101 can add an inventory item, such as a Property 370, to a Wishlist 342. A Wishlist 342 can be used for such reasons as allowing a Sponsor 310 to keep track of inventory items that they may want to recall at a later date. A user may want to Add/Edit Wishlist 344 or Update Wishlist 346. A Sponsor 310 can add an inventory item from a Wishlist 342 into a Campaign 320, can remove an inventory item being considered for a Campaign 320, or can make any other suitable Update Wishlist 346 change.

The system and method 300 can include the ability for the Sponsor 310 to make any suitable change to Sponsor Users 347 to Add/Edit User 313, and Update User 314. This may include the ability to set user 101 restriction access in the system 101 to any other suitable update, including adding or deleting a user 101.

Referring to FIG. 3, system and method 300 illustrates one version of a Property 370 that can include operation of the system 100 by a property user. The Property 370 can View Property 371, which include showing the Property 370 any aspect of the property account. This may be the same view that a Sponsor 310 can see when viewing a Property 370 and such display can be provided on a Dashboard 398. This can be a way for a Property 370 to see what a visiting Sponsor 310 would see when viewing the account. Another step may include the ability for a Property 370 to Add/Edit Property 372 details, which may be demographics, videos, testimonials, statistics, images, or the like, and it will be appreciated that this can include any other suitable property or property owner information. The Property 370 can be able to Update Property 374 in real time or near real time.

Method 300 can include a step for a Property 370 to create Inventory 380, which may include a title, description, image, video, tagged words, or any other relevant information for an inventory asset or a plurality of inventory assets. This inventory can be anything that a property can sell as a sponsorship or partnership opportunity and can include a sign, radio spot, hospitality suite, tickets, giveaways, meet and greet voice over by celebrity, or the like. A Property 370 can be able to View Inventory 382, Add/Edit Inventory 383, and Update Inventory 384. A Property 370 may want to control what information if viewable to Sponsors 310. This can include showing all or none of the available Inventory 380 at any time, or refraining from showing particular information from an Inventory 380 such as price or any other viewable or non-viewable information.

The Inventory 370 can include expanding upon what was learned about a particular sponsorship asset. Information can evolve with additional user 101 input and new learning can be being discovered. This information can include new images, association with white paper, description of how better to activate the sponsorship, or any other suitable additional type of intelligence.

Properties 370 can also access Inventory 380 by searching content, which can be similar to that of Search Properties 332 associated with Sponsors 310. An inventory search can include the ability for a user 101 to search (or pair) by price, date range, category type, tag words, or any other suitable data point a single or multiple Properties 370 simultaneously. The system can then yield results accordingly. It is also appreciated the search includes any combination of one or multiple search criteria.

System and method 300 can include a Property Campaign 386. It is appreciated that a Property Campaign 386 can include one or more sponsorship inventory items. This can include, for a Property 370, to Add/Edit Campaign 390, which may include adding or deleting items, changing costs, bulk rating, changing the terms, or any other suitable type of modification. The Property 370 can Update Campaign 391 changes at any suitable time. At any time the Property 370 can be able to View Campaign 389 such as with the Dashboard 398.

Method 300 can include the ability for a Property 370 or Sponsor 310 to Process Quote 388, 326. This can include the ability to change price, terms, add/delete items, or any other suitable modification. This information can be readily available in real time or near real time. Method 300 can include the ability to Sign Documents 387. This can include the ability for either party or user 101 to enlist additional signers, make modifications and store changes, control the latest contract, add additional terms or additional contracts, or any other suitable change. Method 300 can allow for Properties 370 to control Property Sponsors 392. This can include the ability to add, remove, or Update Sponsor Access 393. Method 300 can include the ability for a Property 370 to make any suitable change to Property Users 394 to Add/Edit User 395, and Update User 396. This can include the ability to set user 101 restriction access in the system 100 to any other suitable update, including adding or deleting a user 101.

Method 300 can include Dashboards 311, 398, 356 for any User Type 302. This may include a Sponsor 310, Property 370 or Administrator 350 User Type 302. Dashboards 311. 398. 356 can be used as a central location to display or highlight account information. This can include the ability to quick links to access information, view total or missing information, link to reports, communicate a snapshot of any suitable information, or otherwise display or communicate relevant account information that can be gathered.

Method 300 can include an Administrator 350 as a User Type 302. This can be understood as system owner control or system manager, for example. This can be a way for the system operator to manage the Properties 370 and Sponsors 310 account in any suitable fashion. This may include assisting with a task, updating user restrictions, assisting with any type of customer service related inquiry, putting a hold on an account, or any suitable account administrator task needed. System and method 300 can include the ability to have an Administrator 350 add additional Users 360. This can include Add/Edit User 362, and Update User 364.

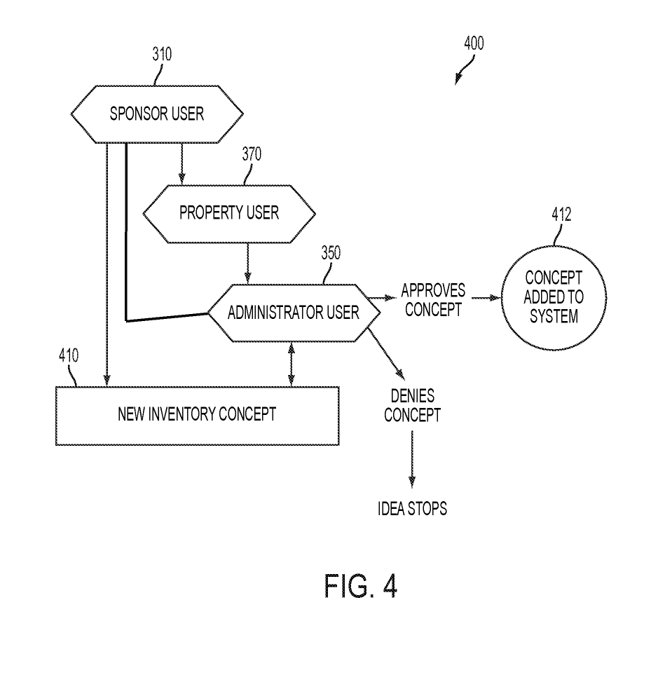

Referring to FIG. 4, one embodiment of a system and method 400 is illustrated, where a Sponsor 310 and Property 370 can collaborate to create new sponsorships or partnerships. Any new sponsorship assets can be added as an inventory item for future purchasing. Sponsorships are constantly being discovered or redefined such that a Property 370 may want to capture pitched sponsorship concepts by adding newly created sponsorships to the system, Property 370 may add, edit, delete, or update any sponsorship at any time. Property 370, Sponsor 310, or Administrator 350 can add or modify sponsorships in accordance with versions of the system 100.

One embodiment can include an Administrator 350 adding a New Inventor Concept 410, which can include a new inventory category, category name, sub category, or the like to the system 100. By adding a New Inventory Concept 410 to the system, all other properties, sponsors, or users may then leverage the new category or sub-category and can utilize the new category. In this manner, the system 100 can grow and adapt based upon user feedback such that the system 100 can remain current with sponsorship or partnership trends. For Properties 370, this can also drive additional sponsorship opportunities as options continue to grow. In one example, a Property 370 can create a sub-category, such as “Flash Mob”, that is not currently listed in the system 100. The Property 370 can list this under a primary category, such as “Performance Sponsorship”, if such a category exists. A Sponsor 310 can view this category and can determine whether they would like more information regarding this opportunity. If the Sponsor 310 or Property 370 feel that the newly suggested category or sub-category could have more global appeal, a suggestion can be made to the Administrator 350. The Administrator 350 can either approve concept and/or the organization of the concept in accordance with Concept Added to System 412, or can deny the concept. In an alternate version, the Administrator 350 can review concepts being suggested or used by Sponsors 310 or Properties 370 and can pro-actively adopt these concepts in the system 100 globally. The New Inventory Category 410 can allow different controls per user type. In one example, a Sponsor 310 user can submit a new inventory item category to a Property 370 and the Property 370 can decide to informally use the new concept. Property 370 can either approve or deny the suggested New Inventory Category 410. If approved, Property 370 could add the item into an existing inventory category or submit the new category concept to Administrator 350 for possible inclusion in the global system 100. Administrator 350 can receive the New Inventory Concept 410 from Sponsor 310, Property 370, or Administrator 350, or can actively seek new concepts being added within the system. Administrator 350 can approve, modify, or deny the suggestion, where in one version only Administrator 350 may have the ability to add a New Inventory Concept 410 globally. If approved, the item can be added to a database, such as database 130, and all properties on the system 100 can use the New Inventory Concept 410 in accordance with Concept Added to System 412. In one embodiment, the Administrator 350 can allow users to vote on New Inventory Concept 410.

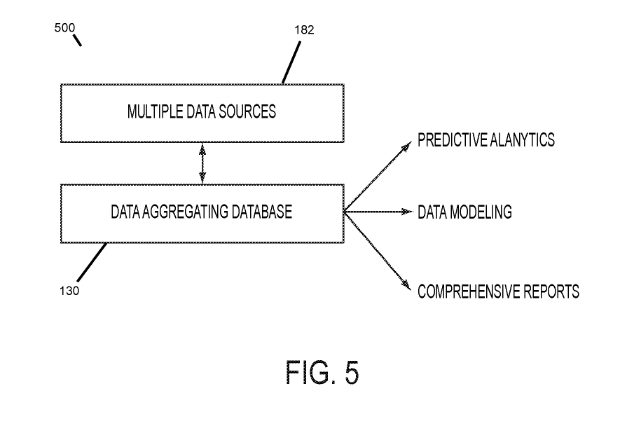

Referring to FIG. 5, one version of a flow chart 500 for one embodiment of how the system 100 can collect multiple data source information from internal and external data sources. In one version, the system 100 can improve the accuracy of the suggested or proposed sponsorship or property matches by aggregating data from Third Party Sources 182. The data collected from Third Party Sources, which can include any suitable information regarding demographics, habits, performance, cost, scheduling, sponsorships, properties, trends, or the like can be compiled by the Database 130 of the computer 180, for example. This information or data collected can be used to create or adjust algorithms associated with sponsorship or property suggestions. FIG. 5 shows that such information can be used for predictive analytics, data modeling, comprehensive reports, or for any other suitable data collection output. The system can also include information related to whether a user 101 found a suggestion helpful to further adjust or modify suggestion algorithms. Any suitable neural network or adjustable weighted algorithm is contemplated to provide accurate suggestions to users 101 of the system 100. In this manner, the system 101 can track trends or otherwise optimize for buyers and sellers such that the sponsorship platform can become more efficient.

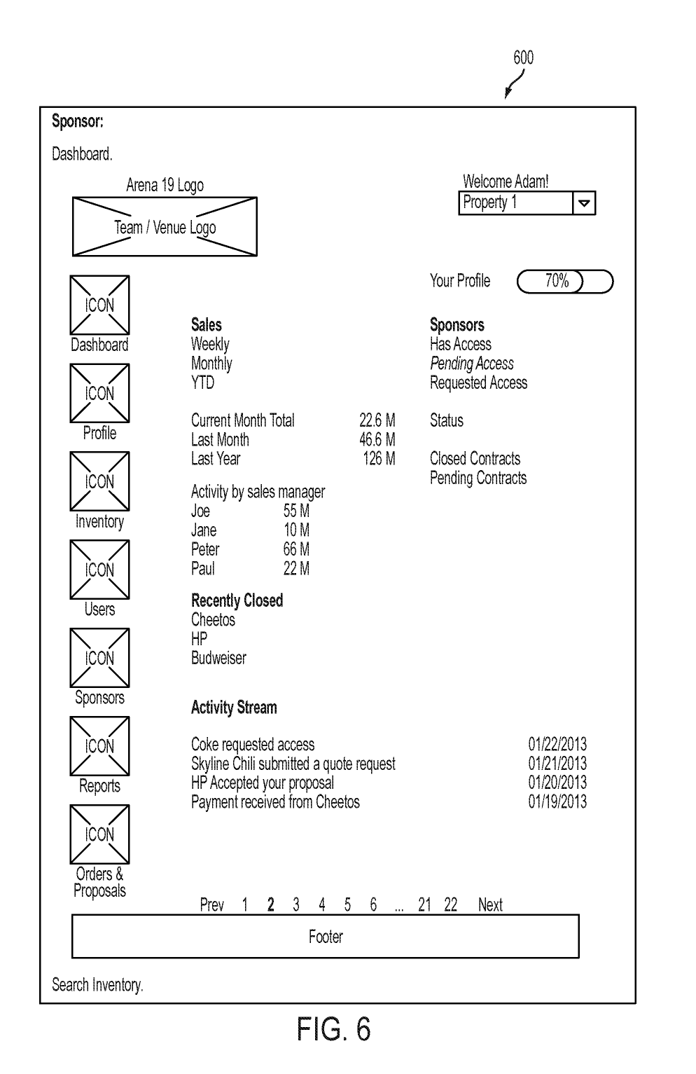

Referring to FIG. 6, one version of a display 600 is shown that can be used for quick access to the most important account information on one screen, which may include clickable links, data points, or any other suitable information. In one embodiment, the display 600 can be associated with Sponsor 310 Dashboard 311, as described with respect to FIG. 3. The display 600 can be generated by the system 100 as described with respect to FIG. 1. In one version, the display 600 can include any suitable number of entry boxes to request any suitable user input. This input can include current monthly spend, links to see which properties Sponsor User has access to viewing, or any other suitable information.

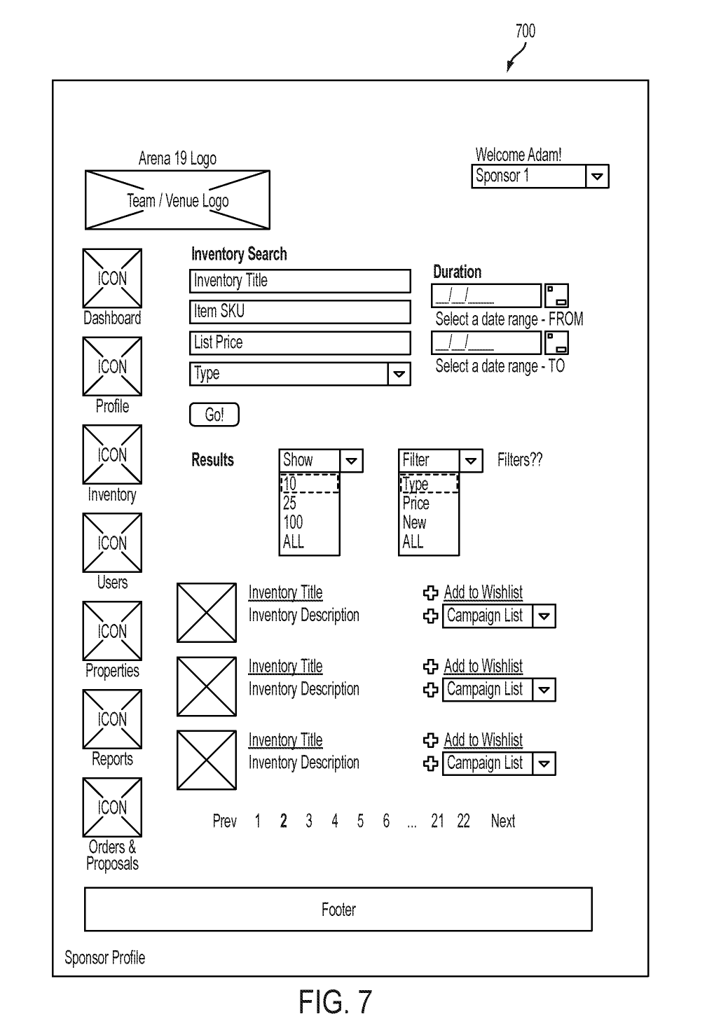

Referring to FIG. 7, one version of a display 700 is shown that can be used to search for inventory items. This may include an advance search or ability to pair a search request to provide suggested properties that meet these requirements. In one embodiment, the display 700 can be associated with Sponsor Properties 330 or Search Property 332, as described with respect to FIG. 3. The display 700 can be generated by the system 100 as described with respect to FIG. 1. In one version, the display 700 can include any suitable number of entry boxes to request any suitable user input. This input can include category search, advance search by date range, or search multiple properties, or any other suitable information. Users 101 may search by one or multiple criteria to yield desired results. Search Properties 332 can also include pairing unique factors. It is appreciated that this may include the ability to pair any information. This can mean if a user is looking to achieve a specific return on objective or return on investment, the pairing can be selected from a pool of objectives, where the system 100 can yield suitable sponsorship assets to match the request. This can also mean matching a user 101 search criteria to yield one or more Properties 370 that may meet the objective(s), or pair to search criteria.

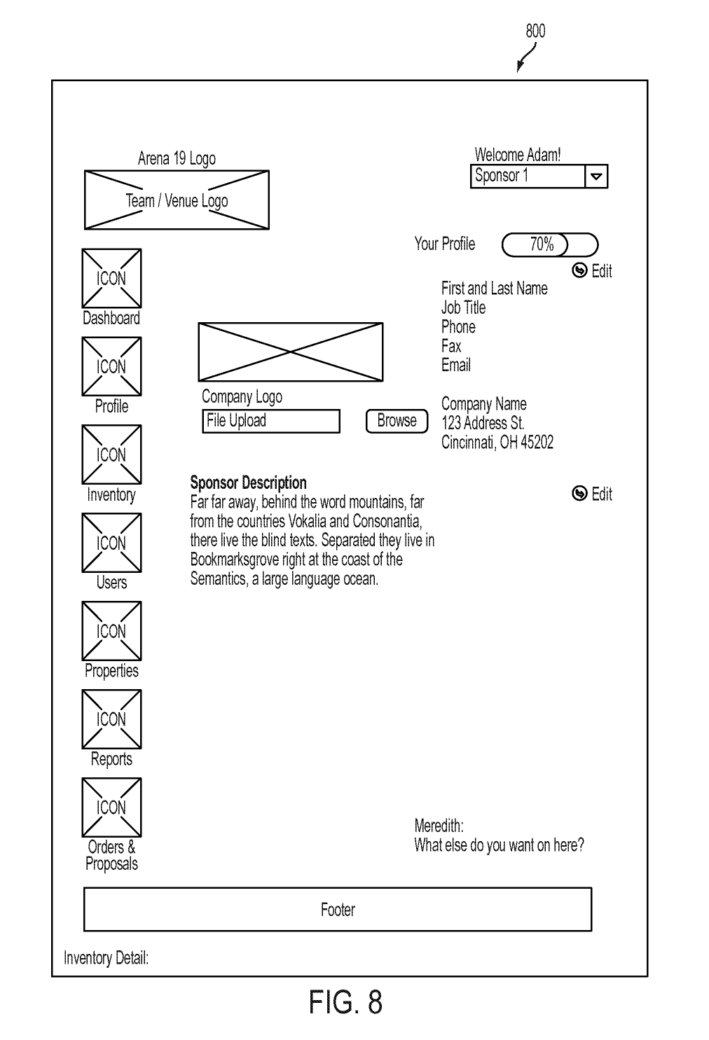

Referring to FIG. 8, one version of a display 800 is shown that can be used to display all account user information. In one embodiment, the display can be associated with Sponsor Profile 312, as described with respect to FIG. 3. The display 800 can be generated by the system 100 as described with respect to FIG. 1. In one version, the display 800 can include any suitable number of entry boxes to cover general account identifies. This input can include a company logo, name, description, contact information, to any other suitable information.

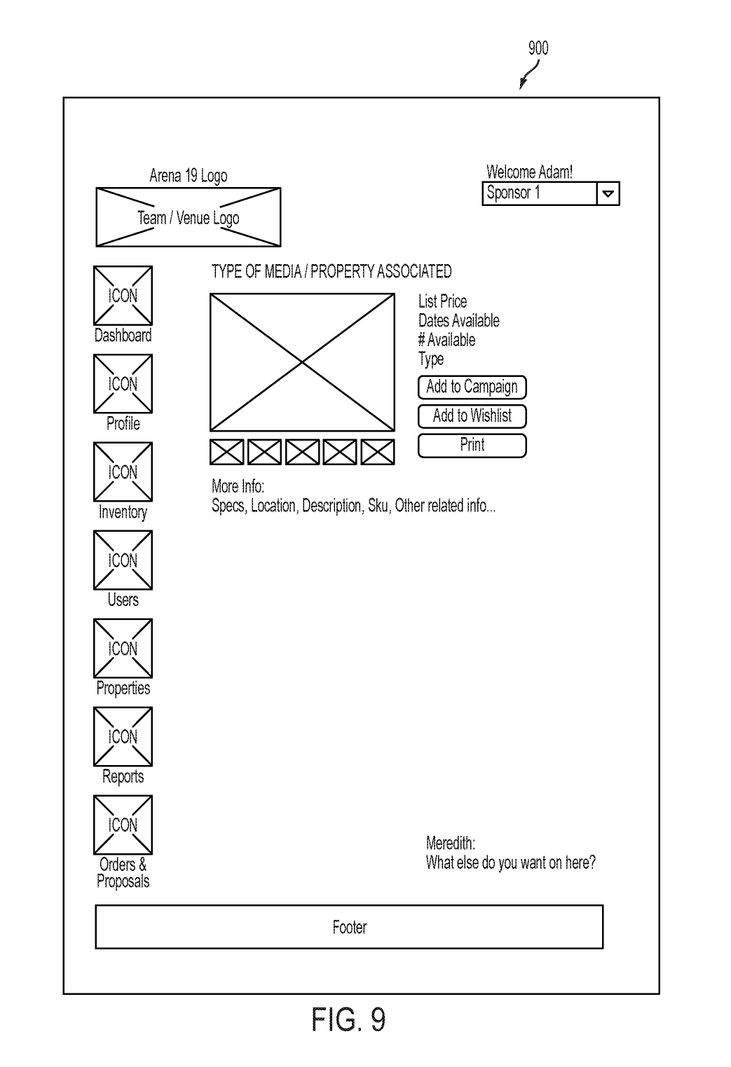

Referring to FIG. 9, one version of a display 900 is shown that can be used to display and collect all information on an inventory asset. In one embodiment, the display 900 can be associated with Property Inventory 380, as described with respect to FIG. 3. The display 900 can be generated by the system 100 as described with respect to FIG. 1. In one version, the display 900 can include any suitable number of fields to convey information about the inventory item. This input can include an image, description, testimonial, video, past success stories, or any other suitable information. This inventory item can be anything that a Property 370 can sell as a sponsorship or partnership opportunity. This may be a sign, radio spot, hospitality suite, tickets, giveaways, meet and greet voice over by celebrity, or any other existing or future created sponsorship concept.

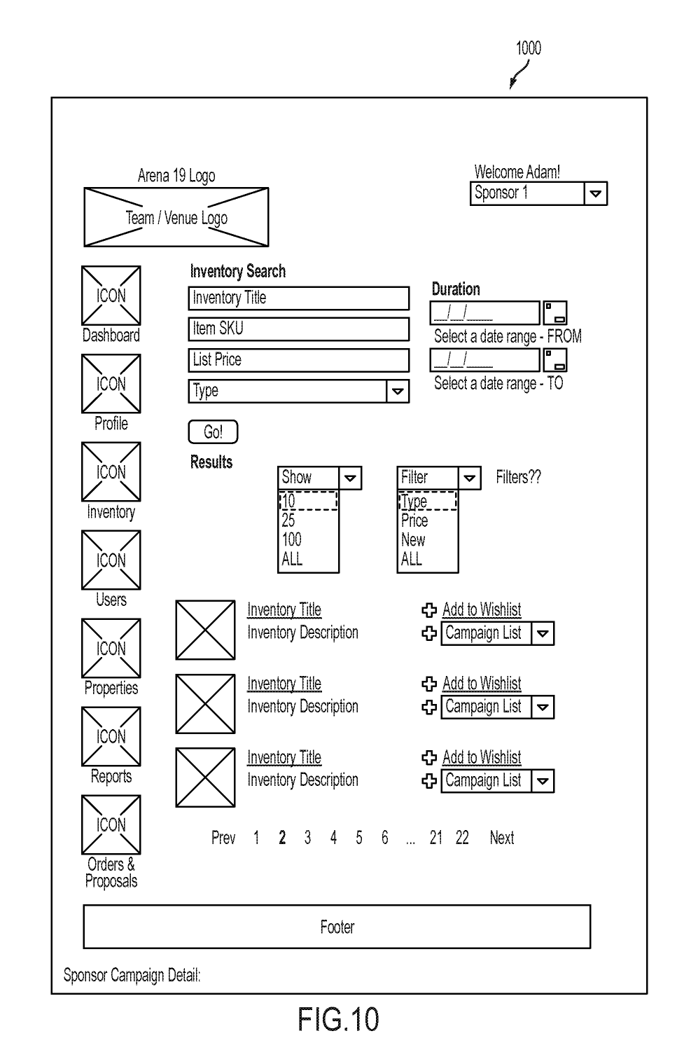

Referring to FIG. 10, one version of a display 1000 is shown that can be used to display a list of campaigns. In one embodiment, the display 1000 can be associated with Campaigns 320, as described with respect to FIG. 3. The display 1000 can be generated by the system 100 as described with respect to FIG. 1. In one version, the display 100 can include a link to open campaigns, View Campaigns 328, Sign Documents 325, Process Quote 326, or another other suitable item. This input can include the ability to view a campaign 320, request revisions, view contract details, or any other suitable information.

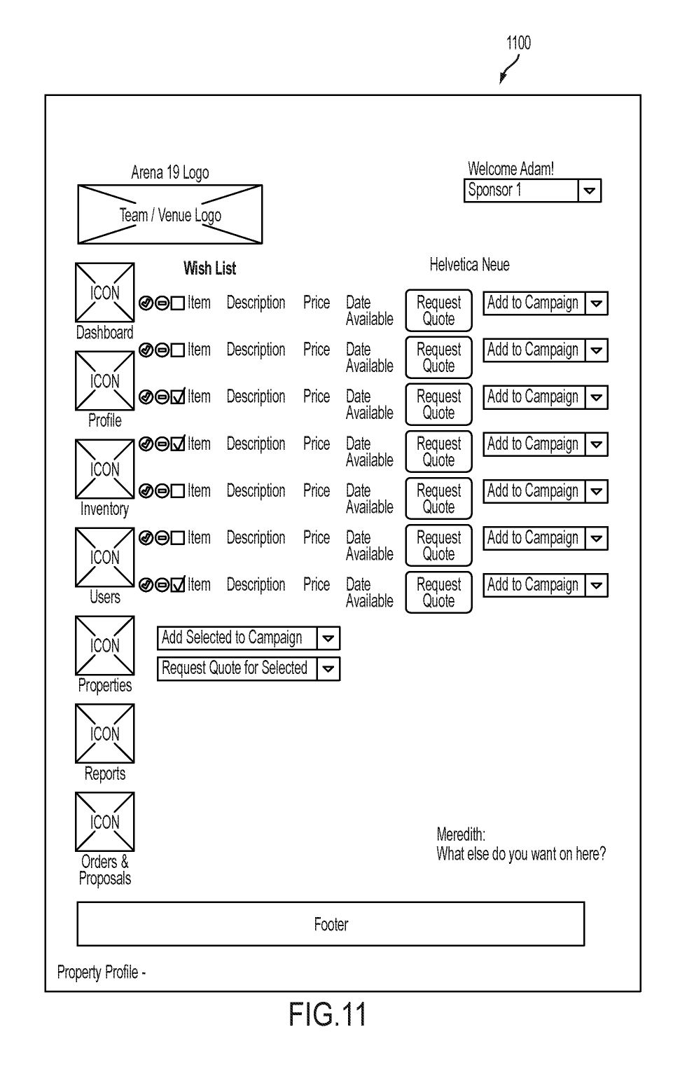

Referring to FIG. 11, one version of a display 1100 is shown that can be used to display inventory items saved and stored in a holding area for future use. In one embodiment, the display 1100 can be associated with Wishlist 342, as described with respect to FIG. 3. The display 1100 can be generated by the system 100 as described with respect to FIG. 1. In one version, the display 1100 can include the Inventory Detail information, such as item name, price, description, etc. This input can include any other suitable information.

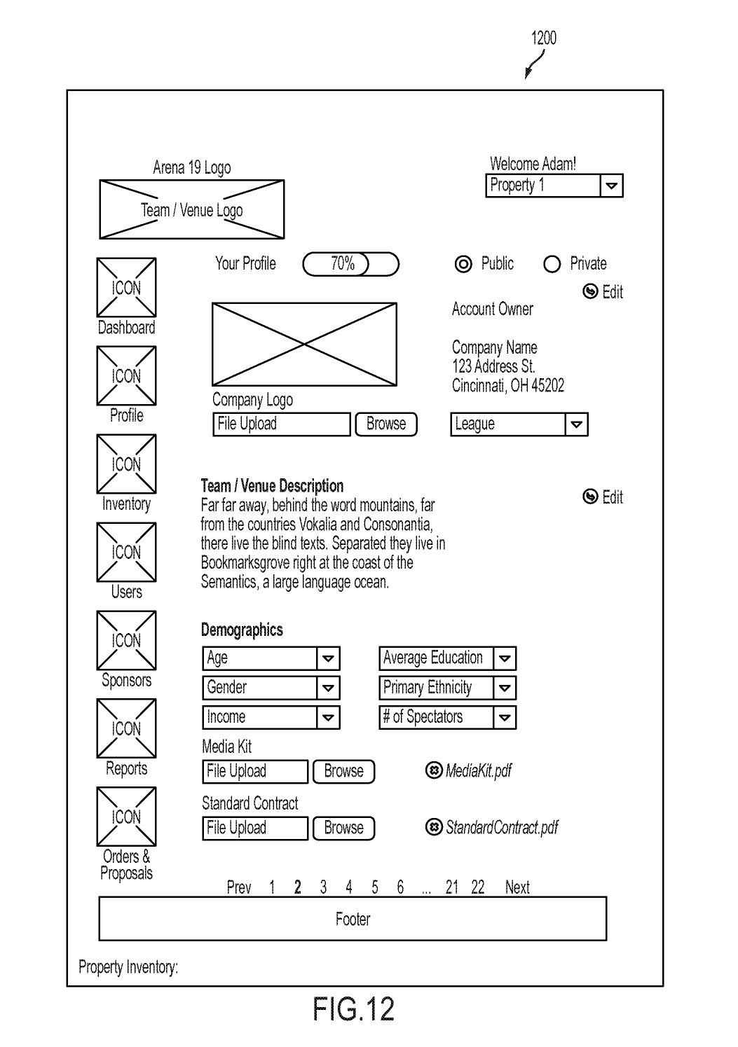

Referring to FIG. 12, one version of a display 1200 is shown that can be used to display all account user information. In one embodiment, the display 1200 can be associated with Property Profile/View Property 371, as described with respect to FIG. 3. The display 1200 can be generated by the system 100 as described with respect to FIG. 1. In one version, the display 1200 can include any suitable number of entry boxes to cover general account identifies. This input can include a company logo, name, description, contact information, to any other suitable information.

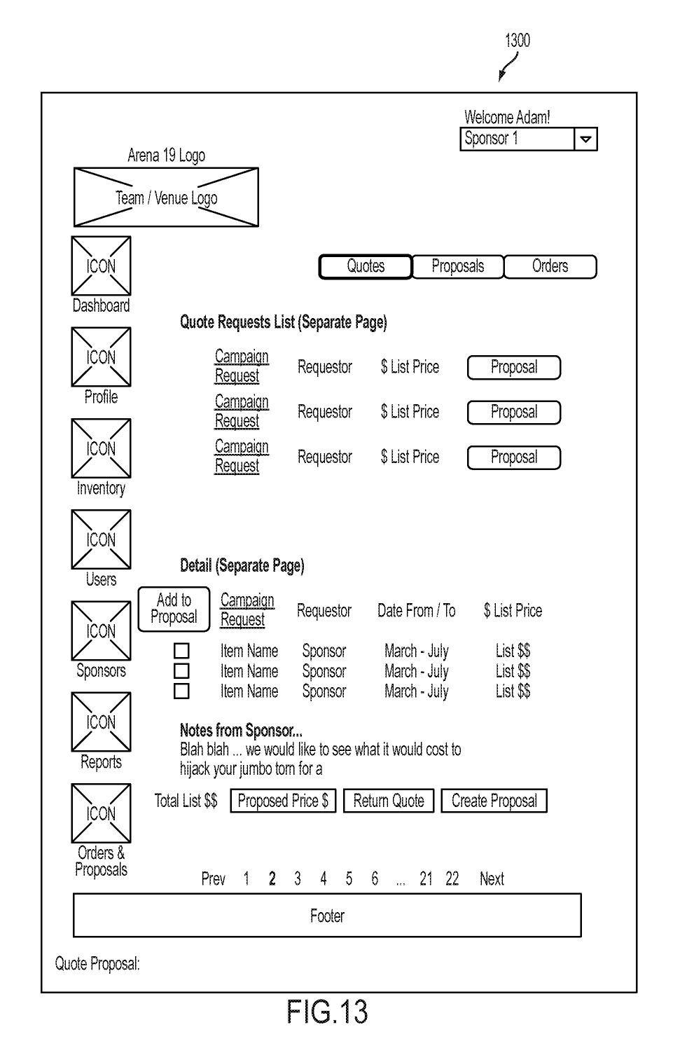

Referring to FIG. 13, one version of a display 1300 is shown that can be used to display quotes, proposals, orders, or any suitable campaign details. In one embodiment, the display 1300 can be associated with Property Campaigns 386, as described with respect to FIG. 3. The display 1300 can be generated by the system 100 as described with respect to FIG. 1. In one version, the display 1300 can include any suitable number of entry boxes or links to obtain campaign or sponsor information. This input can include a list of sponsors, a button to view proposals, the ability to Update Campaign 389, or any other suitable information.

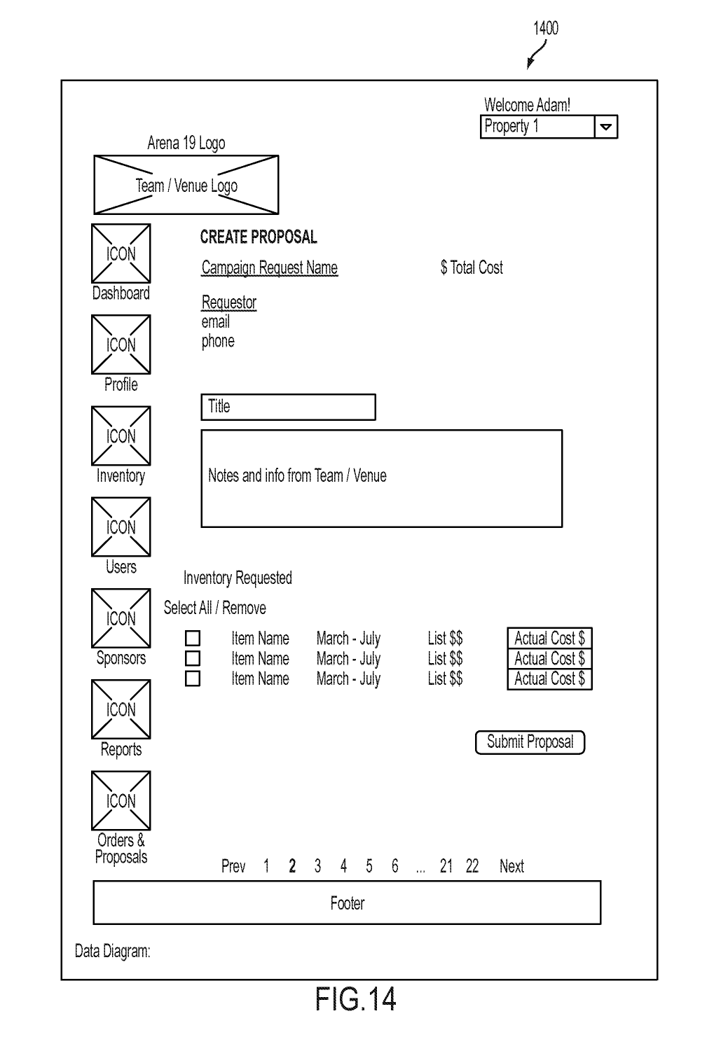

Referring to FIG. 14, one version of a display 1400 is shown that can be used to display proposal details to create a proposal. In one embodiment, the display 1400 can be associated with Property Campaigns 386, as described with respect to FIG. 3. The display 1400 can be generated by the system 100 as described with respect to FIG. 1. In one version, the display 1400 can include any suitable number of entry boxes to cover proposal details. This input can include a proposal title, the associated inventory items, pricing, bulk pricing, or any other suitable information.

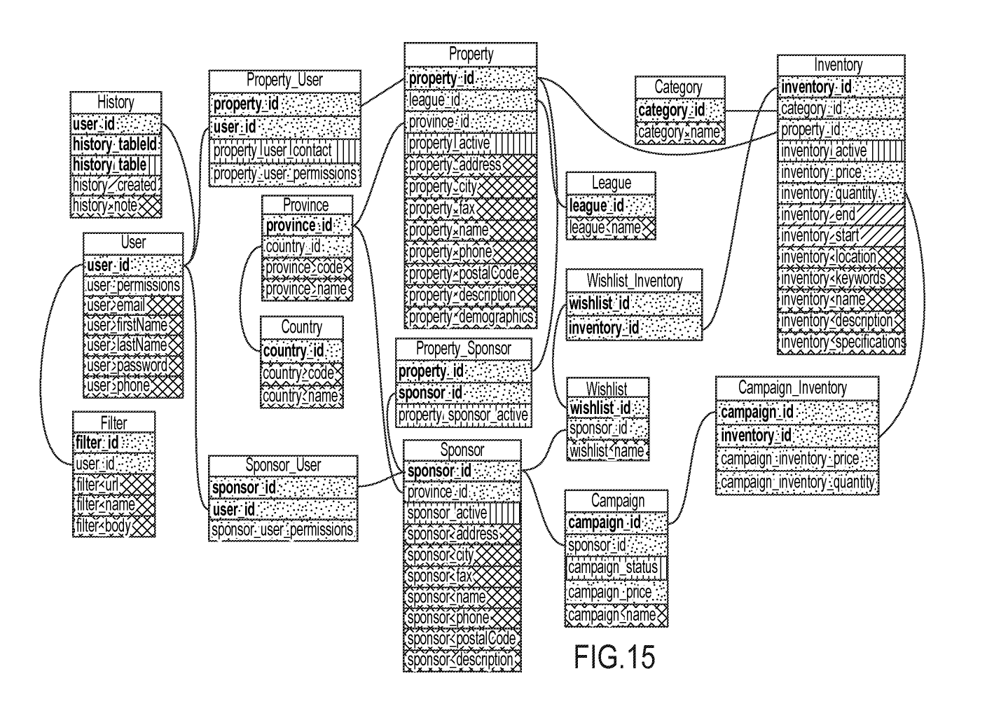

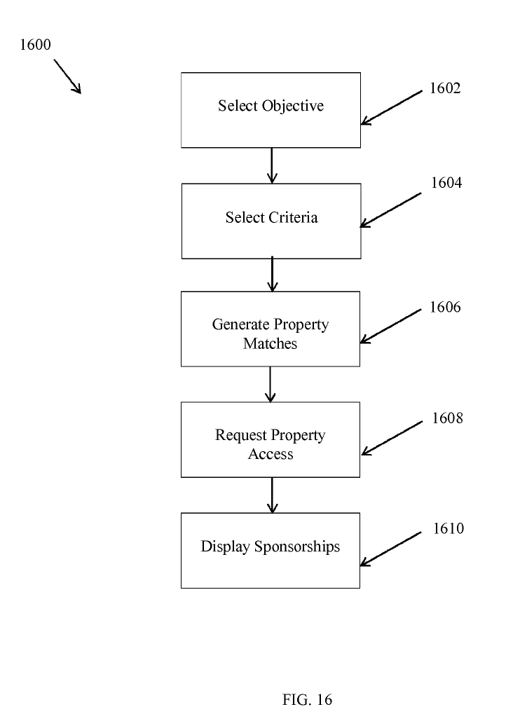

FIG. 15 illustrates one version of a data flow diagram that can be associated with the system 100. It will be appreciated that the data flow diagram is provided by way of example only. It will be appreciated the categories and sub-categories illustrated in FIG. 15 can be associated with Select Criteria 1604 as described in more detail with reference to method 1600 shown in FIG. 16. It will be appreciated that any suitable category having any suitable heading or sub-categories can be provided such that a user 101 can select from a wide range of available search options for criteria. With reference to FIG. 5, it will be appreciated that the system 100 can be optimized such that the system 100 can identify and report accurate pairings for sponsorships or properties based upon the selected objectives and criteria of the user 101.

Referring to FIG. 16, one version of a method 1600 for providing targeted sponsorship suggestions to a user 101. It will be appreciated that the method 1600 can be performed by the system 100 or by any other suitable method or system. In one embodiment, a user 101 can Select Objective 1602, where Select Objective can include a Sponsor 310 accessing a Dashboard 311 that includes a number of objective categories to choose from. Most Sponsors 310, for example, are generally looking for the same types of return on investment from their sponsorship dollars. These categories can include “higher sales”, “more traffic”, “higher name recognition”, “increased engagement”, or the like. For example, there may be twenty primary types of objectives for users 101 and these can be input into the Dashboard 311. When a user 101 access the Dashboard they can access the available list of objectives or potentially input their own objective in accordance with Select Objectives 1062. It will be appreciated that any suitable type and number of objectives can be chosen.

Once a user 101 has selected one or a plurality of objectives, the user 101 can Select Criteria 1604 in accordance with method 1600. Select Criteria can include selecting specific information that can more clearly define the objectives selected with respect to Select Objective 1602. For example, a Sponsor 310 may select “increase sales” as a category with respect to Select Objective 1602, where the user 101 can then select type or criteria information such as “35-45 year old females” for Select Criteria 1604. Although any suitable criteria and sub-criteria are contemplated, it will be appreciated that FIG. 15 illustrates a number of example categories and sub-categories that can be used in accordance with method 1600. Any suitable criteria such as age, age range, gender, habits, country, region, state, city, history, user, company, venue, field, or the like is contemplated. It will be appreciated that the method 1600 may be attractive to national Sponsors 310 that are trying to penetrate regional or local markets, for example. The national Sponsor 310 may not have sufficient knowledge of a local market to quickly assess the most effective way to achieve their objectives based upon their criteria. In this manner, the system 100 may be able to quickly generate attractive properties or sponsorship options to a potential Sponsor 310.

Once a user 101 has selected one or a plurality of criteria, including inputting new criteria, the method 1600 can transition to Generate Property Matches 1606. The system 100 can use the selected category and criteria information to generate associated sponsorship opportunities or properties that match the selected preferences. With reference to FIG. 5, the system 100 can access outside information or Big Data to provide comprehensive analysis or data regarding matching decisions. If a Property 370 is matched that the user 101 has access to, then the system 100 can generate the list of available sponsorships. If the matched Property 370 is not yet accessible by the Sponsor 310, the Sponsor 310 can Request Property Access 1608. If the access is granted by the Property 370 then a list of available sponsorship can be provided to the Sponsor 310. It will be appreciated that method 1600 can provide intelligently matched options for Sponsors 310 and Properties 370 without revealing the specific sponsorships for a Property 370 without consent. Properties 370 may be very cautious about publicizing available information, where a Property 370 can deny a Sponsor 310 access in one version. In an alternate version, a Sponsor 310 can also conceal all or a part of their identity until required or asked by a Property 370, for example.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signal.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A manufacture, comprising a non-transitory non-volatile computer-readable storage device including computer-readable code for managing a sponsorship transaction and interpretable by a processor to cause a computing system to perform a process including:
presenting to a user a human-readable representation of a plurality of objectives;
receiving from the user a designated business objective;
storing, in a first data record of a database, the designated business objective;
presenting to the user a human-readable representation of a plurality of criteria;
receiving from the user a designated criteria;
storing, in the database, the designated criteria in a second data record;
based on receiving the designated business objective and the designated criteria, matching a property; and
presenting to the user a human-readable representation of the property.

2. A sponsorship management computer system substantially as shown and described herein.

3. A method of managing sponsorships using a sponsorship management computer system, the method being substantially as shown and described herein.
